(19) United States
(12) Patent Application Publication
(10) Pub. No.: US 2011/0062009 A1
(43) Pub. Date: Mar. 17, 2011

(54) KEYBOARD DEVICE

(75) Inventor: Jung-Yu Peng, Taipei County (TW)

(73) Assignee: ELITES ELECTRONICS CORP., TAIPEI COUNTY (TW)

(21) Appl. No.: 12/781,829

(22) Filed: May 18, 2010

(30) Foreign Application Priority Data
Sep. 17, 2009 (TW) 98131388

(51) Int. Cl. H01H 13/76

(52) U.S. Cl. 200/5 A

(57) ABSTRACT

A keyboard device including a frame made of two materials, a keypad film, and multiple button assemblies is provided. The frame made of two materials includes a bottom plate and multiple fixing structures, wherein the fixing structures are integrally formed at the bottom plate by in-mold injection. The keypad film is disposed on the frame made of two materials, and the button assemblies are disposed on the keypad film and assembled to the fixing structures.

### CROSS-REFERENCE TO RELATED APPLICATION

This application claims the priority benefit of Taiwan application serial no. 98131388, filed on Sep. 17, 2009. The entirety of the above-mentioned patent application is hereby incorporated by reference herein and made a part of specification.

### BACKGROUND OF THE INVENTION

1. Field of the Invention

The invention relates to a device, and in particular relates to a keyboard device.

2. Description of Related Art

FIG. 1 is a schematic view depicting a frame of a conventional keyboard device. Referring to FIG. 1, a frame 100 of the conventional keyboard device is fabricated by processing a metal plate 110 to form fixing structures 120 and constraining structures 130 on a bottom plate. More specifically, the metal plate 110 is punched and bent several times, so as to form the fixing structures 120 and the constraining structures 130. Generally speaking, the punching and bending processes are performed 6-8 times. Therefore, the material of the fixing structures 120 and the constraining structures 130 is the same as the material of the metal plate 110.

Since the processes are performed so many times, the production costs cannot be lowered. In addition, the metal may easily break after being bent several times, resulting in the poor yield rate of the frame 100. As a consequence, the costs for fabricating the frame 100 are high.

### SUMMARY OF THE INVENTION

The invention provides a keyboard device requiring low production costs.

The invention provides a keyboard device, including a frame, a keypad film, and a plurality of button assemblies. The frame includes a bottom plate and a plurality of fixing structures, wherein the fixing structures are located on the bottom plate. Moreover, the fixing structures and the bottom plate are integrally formed by in-mold injection. The keypad film is disposed on the frame. The button assemblies are disposed on the keypad film and assembled to the fixing structures.

According to an embodiment of the invention, a material of the bottom plate is metal.

According to an embodiment of the invention, a material of the fixing structures is plastic.

According to an embodiment of the invention, the keypad film includes a plurality of push switches, and the button assemblies are correspondingly disposed on the push switches.

According to an embodiment of the invention, the keypad film has a plurality of openings, and the openings are disposed corresponding to the fixing structures.

According to an embodiment of the invention, each of the fixing structures includes a pair of positioning bumps and a pair of constraining bumps, wherein each of the button assemblies is assembled to one pair of positioning bumps, and the constraining bumps are disposed opposite to the positioning bumps corresponding thereto. In addition, each of the button assemblies includes a first holder, a second holder, and a key cap, wherein an end of the first holder is assembled to one pair of positioning bumps, and the second holder is pivotally assembled to the first holder and constrained by the corresponding constraining bumps. The key cap is assembled to the first holder and the other end of the second holder that is not assembled to the fixing structures.

According to an embodiment of the invention, the bottom plate has a plurality of through holes, and each of the fixing structures passes through the corresponding through hole to be formed on the bottom plate. The bottom plate further includes a plurality of protrusive structures, and the through holes are located in the protrusive structures correspondingly.

Based on the above, the frame in the keyboard device of the invention is formed by in-mold injection. Therefore, the processes performed during the fabrication of the frame are reduced, the production costs are lowered, and the yield rate is increased.

In order to make the aforementioned and other features and advantages of the invention more comprehensible, several embodiments accompanied with drawings are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view depicting a frame of a conventional keyboard device.

FIG. 2 is a flowchart illustrating a method for forming a frame of a keyboard device according to the present embodiment.

FIG. 3 depicts the frame formed by the process as shown in FIG. 2.

FIG. 4 is a schematic view of a keyboard device equipped with the frame fabricated by the processes shown in FIG. 2.

FIG. 5A is a cross-sectional view of a frame according to another embodiment of the invention.

FIG. 5B is a perspective view of FIG. 5A.

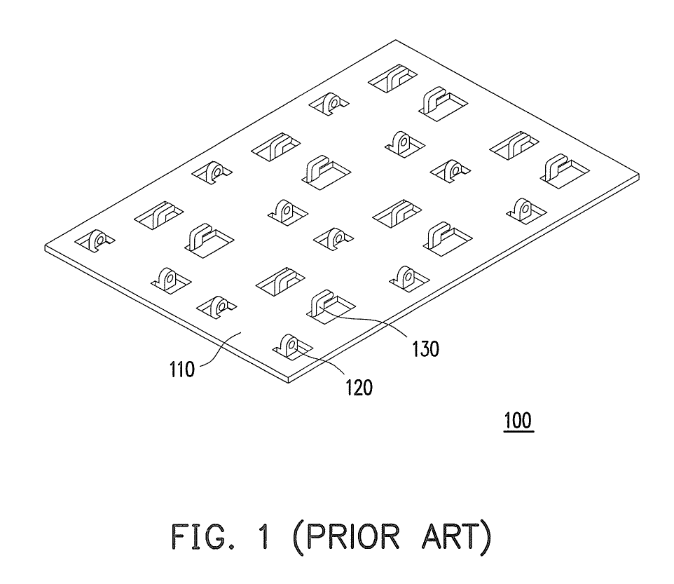

### DESCRIPTION OF EMBODIMENTS

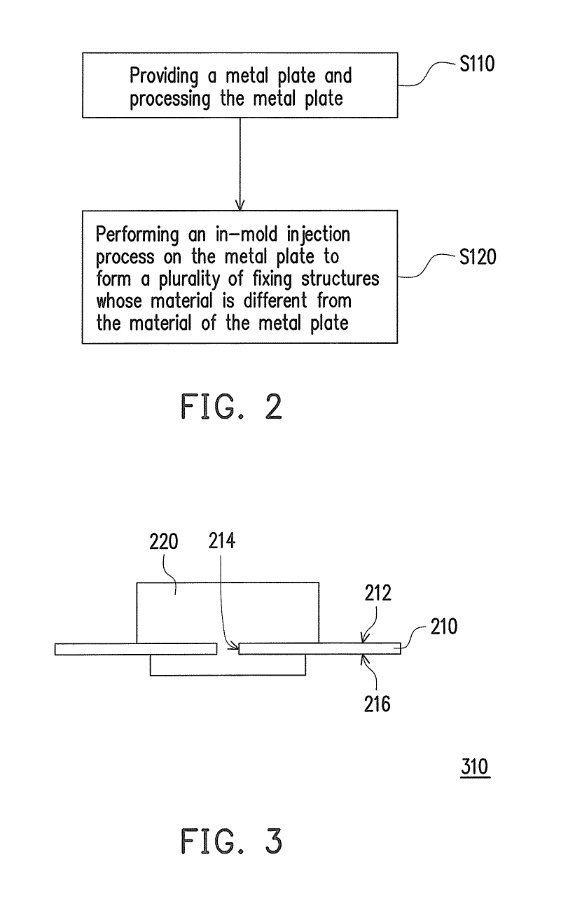

FIG. 2 is a flowchart illustrating a method for forming a frame of a keyboard device according to the present embodiment, and FIG. 3 depicts the frame formed by the process shown in FIG. 2. Referring to FIGS. 2 and 3, as shown in Step S110, a metal plate 210 is provided and processed. A method for processing the metal plate 210 is to punch the metal plate 210, so as to form a plurality of through holes 214 in the metal plate 210. Thereafter, as in Step S120, an in-mold injection process is performed on the metal plate 210 to form a plurality of fixing structures 220 for constituting a frame 310. A material of the fixing structures 220 is different from the material of the metal plate 210.

To be more specific, the punched metal plate 210 is placed in a mold. Next, a plastic molding material is filled into the mold to flow from a surface 212 of the metal plate 210 to the other surface 216 thereof through the through holes 214 and then cures to form the fixing structures 220 on the metal plate 210. A direction of filling in the plastic molding material can be varied according to actual requirements and is not limited to the descriptions here or the illustration of FIG. 3. It is noted that, after flowing from the surface 212 into the through holes 214, the plastic molding material covers the surface 216 and cures thereon. The fixing structures 220 formed by curing the continuous-fluid plastic molding material is shaped like “I,” and the fixing structures 220 are securely fixed on the metal plate 210.

Compared with the conventional frame, the frame 310 that is formed by in-mold injection requires fewer fabricating processes and thus has better yield rate.

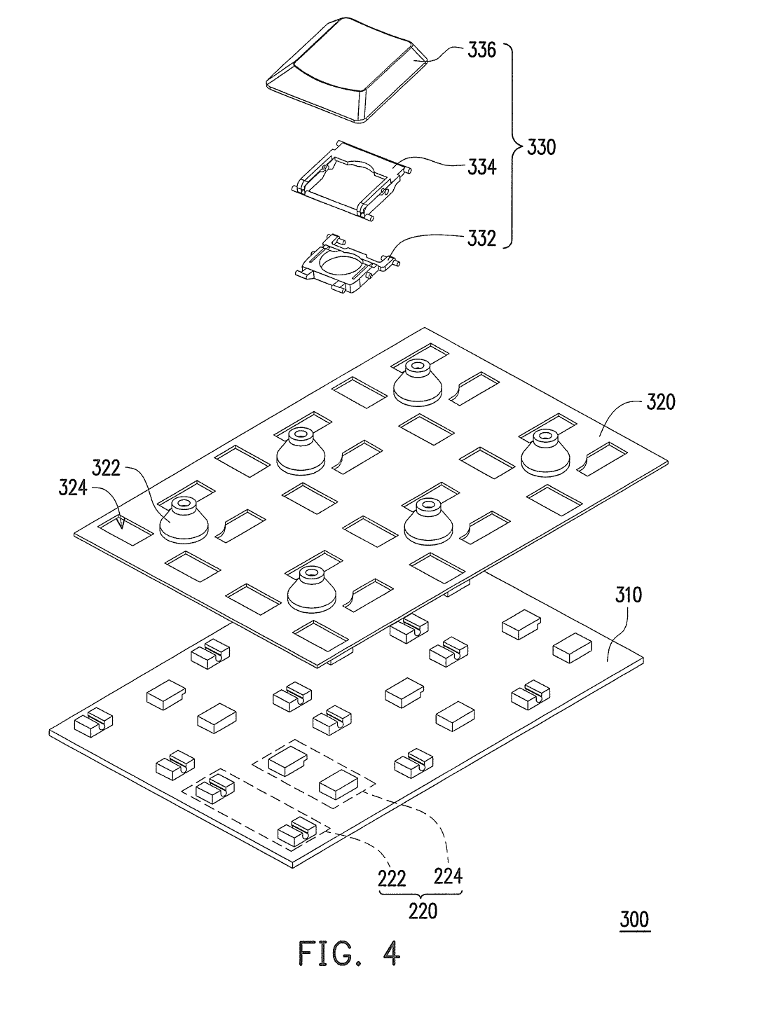

The frame 310 fabricated by the above-described processes can be applied in a keyboard device. FIG. 4 is a schematic view of a keyboard device equipped with the frame fabricated by the processes shown in FIG. 2. Referring to FIG. 4, a keyboard device 300 includes the frame 310 fabricated by the aforementioned processes, a keypad film 320, and a plurality of button assemblies 330. The structure and fabricating method of the frame 310 have been described in the above, and therefore not repeated hereinafter. The keypad film 320 is disposed on the frame 310. The button assemblies 330 are disposed on the keypad film 320 and assembled to the fixing structures 220 of the frame 310.

Furthermore, the keypad film 320 includes a plurality of push switches 322, and the button assemblies 330 are disposed on the push switches 322. When the button assemblies 330 are pressed, the push switches 322 are pushed by the button assemblies 330 to switch on. Moreover, the keypad film 320 has a plurality of openings 324 disposed corresponding to the fixing structures 220, so as to expose the fixing structures 220 for assembling the button assemblies 330 thereon.

More specifically, each of the fixing structures 220 includes a pair of positioning bumps 222 and a pair of constraining bumps 224, wherein each of the button assemblies 330 is assembled to one pair of the positioning bumps 222, and the constraining bumps 224 are disposed opposite to the positioning bumps 222 corresponding thereto. In addition, each of the button assemblies 330 includes a first holder 332, a second holder 334, and a key cap 336, wherein an end of the first holder 332 is assembled to one pair of the positioning bumps 222, and the second holder 334 is pivotally assembled to the first holder 332. An end of the second holder 334 is constrained by the corresponding constraining bumps 224. Thus, the end of the second holder 334 can move horizontally, not vertically. The key cap 336 is assembled to the first holder 332 and the other end of the second holder 334 that is not assembled to the fixing structures 220.

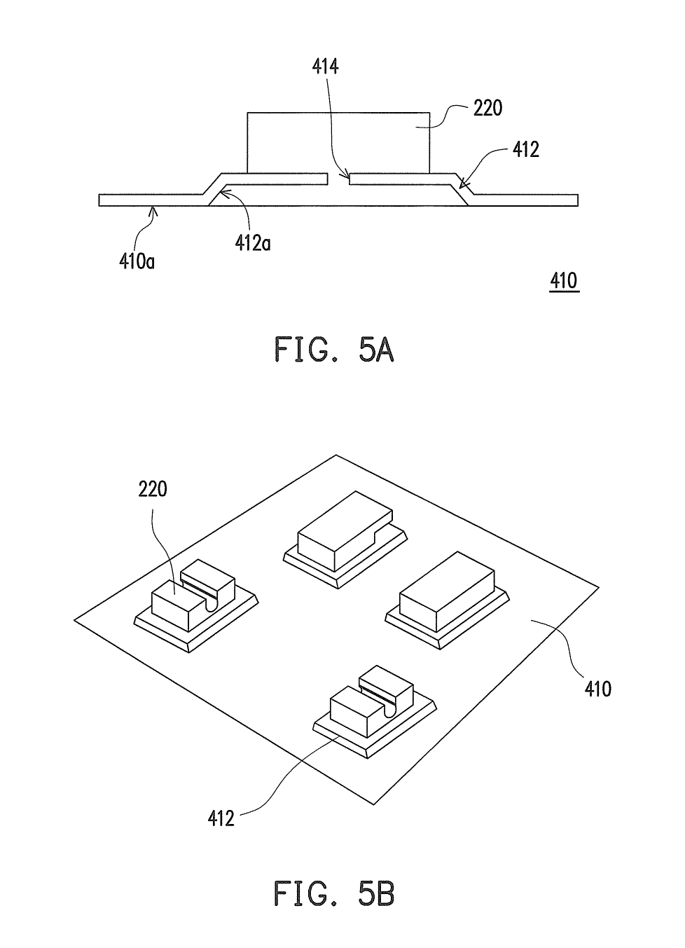

FIG. 5A is a cross-sectional view of a frame according to another embodiment of the invention, and FIG. 5B is a perspective view of FIG. 5A. With reference to FIGS. 5A and 5B, in other embodiments, a bottom plate 410 further includes a plurality of protrusive structures 412. The through holes 414 are formed in the protrusive structures 412 correspondingly. Due to the protrusive structures 412, the plastic molding material is cured in a recession 412a on an opposite surface of the protrusive structures 412. Consequently, a surface 410a of the bottom plate 410 can be maintained smooth to increase the stability of assembly. In other embodiments, a direction of filling the plastic molding material and a curing position of the plastic molding material can be varied according to actual requirements.

In conclusion of the above, the frame in the keyboard device of the invention is formed by in-mold injection. The processes performed during the fabrication of the frame are reduced. Accordingly, the production costs are lowered and the yield rate is increased.

Although the invention has been described with reference to the above embodiments, it is apparent to one of ordinary skill in the art that modifications to the described embodiments may be made without departing from the spirit of the invention. Accordingly, the scope of the invention is defined by the attached claims not by the above detailed descriptions.

What is claimed is:

1. A keyboard device, comprising:
a frame, comprising:
a bottom plate;
a plurality of fixing structures disposed on the bottom plate, wherein the fixing structures and the bottom plate are integrally formed by in-mold injection;
a keypad film disposed on the frame; and
a plurality of button assemblies disposed on the keypad film and assembled to the fixing structures correspondingly.

2. The keyboard device as claimed in claim 1, wherein a material of the bottom plate is metal.

3. The keyboard device as claimed in claim 1, wherein a material of the fixing structures is plastic.

4. The keyboard device as claimed in claim 1, wherein the keypad film comprises a plurality of push switches, and the button assemblies are correspondingly disposed on the push switches.

5. The keyboard device as claimed in claim 1, wherein the keypad film has a plurality of openings, and the openings are positioned correspondingly to the fixing structures.

6. The keyboard device as claimed in claim 1, wherein each of the fixing structures comprises:
a pair of positioning bumps, wherein each of the button assemblies is assembled to the positioning bumps corresponding thereto; and
a pair of constraining bumps disposed opposite to the pair of positioning bumps.

7. The keyboard device as claimed in claim 6, wherein each of the button assemblies comprises:
a first holder having an end assembled to the pair of positioning bumps corresponding thereto;
a second holder pivotally assembled to the first holder, wherein the second holder is constrained by the pair of constraining bumps corresponding thereto; and
a key cap assembled to the first holder and the other end of the second holder, the other end of the second holder being not assembled to the fixing structures.

8. The keyboard device as claimed in claim 1, wherein the bottom plate has a plurality of through holes, and each of the fixing structures passes through the corresponding through hole to be formed on the bottom plate.

9. The keyboard device as claimed in claim 8, wherein the bottom plate further comprises a plurality of protrusive structures, and the through holes are positioned in the protrusive structures correspondingly.
